(19) United States
(12) Patent Application Publication
(10) Pub. No.: US 2013/0134912 A1
(43) Pub. Date: May 30, 2013

(54) Switched Reluctance Machine Natural Transition between Current Regulation and Single Pulse Operation

(71) Applicants: Ahmed Khalil, Peoria, IL (US); Jackson Wai, Dunlap, IL (US); Jesse Gerdes, Dunlap, IL (US)

(72) Inventors: Ahmed Khalil, Peoria, IL (US); Jackson Wai, Dunlap, IL (US); Jesse Gerdes, Dunlap, IL (US)

(73) Assignee: CATERPILLAR, INC., Peoria, IL (US)

(21) Appl. No.: 13/307,119

(22) Filed: Nov. 30, 2011

(51) Int. Cl. H02P 23/00

(52) U.S. Cl. 318/400.11

(57) ABSTRACT

A method of controlling a motor is provided. The method may monitor a plurality of operational characteristics of the motor, determine an optimum transition speed of the motor based on the operational characteristics, and engage a transition of the motor between a current regulation mode of operation and a single pulse mode of operation at the optimum transition speed.

### TECHNICAL FIELD

The present disclosure relates generally to electric motors, and more particularly, to systems and methods of controlling the transition of switched reluctance motors between different modes of operation.

### BACKGROUND

With the growing interest in energy conservation, increasingly more industrial work machines are supplied with electric drive assemblies for driving the work machine and operating its various tools or functions. Ongoing developments in electric drives have made it possible for electrically driven work machines to effectively match or surpass the performance of purely mechanically driven work machines while requiring significantly less fuel and overall energy. As electric drive assemblies become increasingly more commonplace with respect to industrial work machines, and the like, the demands for more efficient generators and techniques for controlling same have also increased.

A generator or an electric motor of an electric drive machine is typically used to convert mechanical power received from a primary power source, such as a combustion engine, into electrical power for performing one or more operations of the work machine. Additionally, an electric motor may be used to convert electrical power stored within a common bus or storage device into mechanical power. Among the various types of electric motors available for use with an electric drive assembly, switched reluctance (SR) motors have received great interest for being robust, cost-effective, and overall, more efficient. While currently existing systems and methods for controlling SR generators provide adequate control, there is still room for improvement.

Typical control schemes for SR motors may involve operating the motor in one of two general operating modes, for example, current regulation and single pulse modes of operation. Current regulation modes are directed toward lower speed tasks requiring more torque output from a driven machine, while single pulse modes are directed toward higher speed tasks requiring more power output. Throughout the use of the machine, the motor is continuously switched between such different modes of operation, and each transition can be very unsmooth. This is mainly because current transitions are executed at transition speeds that are dictated by fixed speed transition limits which remain constant regardless of torque loading conditions. Such unsmooth and unnatural transitions between operating modes in such machines can amount to a substantial loss of machine power and torque utilization over time, and thus, a significant loss in the overall efficiency of the machine.

Accordingly, there is a need to improve the overall efficiency and functionality of an electric drive assembly. Moreover, there is a need to improve machine power and torque utilization across the transition speed region and provide a more natural transition between different modes of operating a switched reluctance motor. Furthermore, there is a need to take into consideration both the load torque and the observed speed of a switched reluctance motor upon making transitions between different operating modes.

### SUMMARY OF THE DISCLOSURE

In one aspect of the present disclosure, a method of controlling a motor is provided. The method may monitor a plurality of operational characteristics of the motor, determine an optimum transition speed of the motor based on the operational characteristics, and engage a transition of the motor between a current regulation mode of operation and a single pulse mode of operation at the optimum transition speed.

In a refinement, the motor may be a switched reluctance motor configured to generate constant torque while operating in the current regulation mode, and generate constant power while operating in the single pulse mode.

In another refinement, the operational characteristics may include data pertaining to at least an actual speed of the motor and a load torque of the motor.

In another refinement, the optimum transition speed may be computed using a predefined function of at least an actual speed of the motor and a load torque of the motor.

In another refinement, the optimum transition speed may be determined using a predefined transition control map configured to output the optimum transition speed based on an actual speed of the motor and a load torque of the motor.

In a related refinement, the transition control map may be preprogrammed with a lookup table having a plurality of optimum transition speed values corresponding to different actual speed and load torque values.

In yet another refinement, the transition may be engaged when motor current reaches a unique single peak value point.

In a related refinement, the motor current may reach the single peak value point when a voltage applied to the motor substantially equates a sum of a back electromotive force (EMF) voltage and a resistive voltage drop at a current reference level for a particular load torque.

In another aspect of the present disclosure, a method of controlling a transition of a switched reluctance motor between current regulation operation and single pulse operation is provided. The method may monitor an actual speed of the motor, monitor a load torque of the motor, determine an optimum transition speed of the motor based on a predefined transition control map, and engage the transition when motor current reaches a unique single peak value point. The transition control map may be configured to output the optimum transition speed based on the actual speed and the load torque of the motor.

In a refinement, the motor may be configured to generate constant torque while operating in the current regulation mode, and generate constant power while operating in the single pulse mode.

In another refinement, the optimum transition speed may be computed using a predefined function of at least the actual speed and the load torque of the motor.

In another refinement, the optimum transition speed may be determined using a predefined transition control map configured to output the optimum transition speed based on the actual speed and the load torque of the motor.

In a related refinement, the transition control map may be preprogrammed with a lookup table having a plurality of optimum transition speed values corresponding to different actual speed and load torque values.

In yet another refinement, the motor current may reach the single peak value point when a voltage applied to the motor substantially equates a sum of a back EMF voltage and a resistive voltage drop at a current reference level for a particular load torque.

In yet another aspect of the present disclosure, a transition control system for a motor is provided. The transition control system may include a control circuit operatively coupled to at least one or more phases of a stator of the motor, and a controller in communication with each of the motor and the control circuit. The controller may be configured to monitor an actual speed and a load torque of the motor, determine an optimum transition speed of the motor based on the actual speed and the load torque, and enable the control circuit to engage a transition of the motor between a current regulation mode of operation and a single pulse mode of operation at the optimum transition speed.

In a refinement, the motor may be a switched reluctance motor capable of operating in one of at least the current regulation mode and the single pulse mode. The current regulation mode may correspond to constant torque output and the single pulse mode may correspond to constant power output.

In another refinement, the optimum transition speed may be computed using a predefined function of at least an actual speed of the motor and a load torque of the motor.

In another refinement, the optimum transition speed may be determined using a predefined transition control map configured to output the optimum transition speed based on the actual speed and the load torque of the motor.

In a related refinement, the transition control map may be preprogrammed with a lookup table having a plurality of optimum transition speed values corresponding to different actual speed and load torque values.

In yet another refinement, the transition may be engaged when motor current reaches a unique single peak value point. The motor current may reach the single peak value point when a voltage applied to the motor substantially equates a sum of a back EMF voltage and a resistive voltage drop at a current reference level for a particular load torque.

### BRIEF DESCRIPTION OF THE DRAWINGS

FIG. 1 is a diagrammatic view of one exemplary machine employing an electric drive assembly;

FIG. 2 is a schematic view of one exemplary embodiment of a transition control system as applied to an electric drive and constructed in accordance with the teachings of the present disclosure;

FIG. 3 is a schematic view of one exemplary layout of a controller for a transition control system; and

FIG. 4 is a flow diagram of one exemplary method of controlling a motor.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

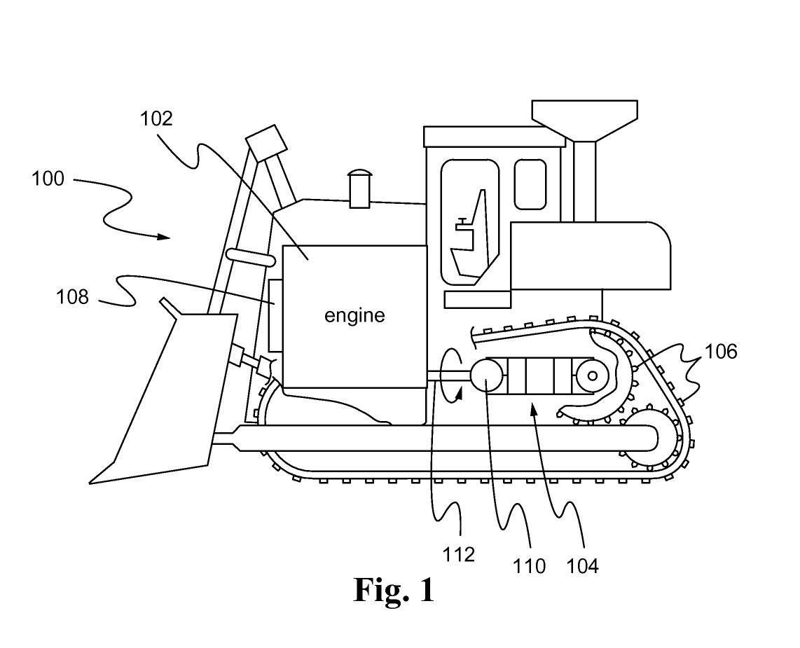

FIG. 1 diagrammatically illustrates a mobile machine 100 that may employ electric drive means for causing movement. More specifically, the machine 100 may include a power source 102 that is coupled to an electric drive 104 for causing movement via a traction device 106. Such a mobile machine 100 may be used as a work machine for performing a particular type of operation associated with an industry, such as mining, construction, farming, transportation, or any other suitable industry known in the art. For example, the machine 100 may be an earth moving machine, a marine vessel, an aircraft, a tractor, an off-road truck, an on-highway passenger vehicle, or any other mobile machine. The power source 102 of the electric drive 104 may include, for example, a diesel engine, a gasoline engine, a natural gas engine, or any other type of combustion engine commonly used for generating power. The engine 102 may be configured to mechanically transmit power to a generator or an electric motor 110 of the electric drive 104 via a coupling or axially rotating drive shaft 112.

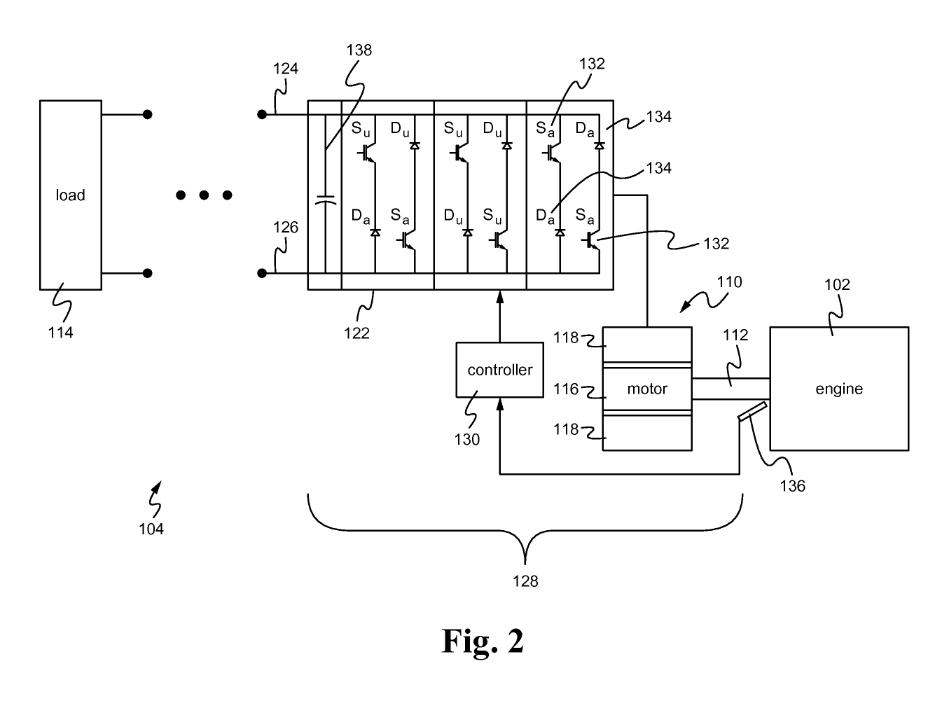

FIG. 2 schematically illustrates one exemplary electric drive 104 that may be employed to communicate power between the engine 102 and one or more electrical loads 114. The motor 110 of the electric drive 104 in FIG. 2 may be a switched reluctance (SR) motor, or the like, configured to produce electrical power in response to rotational input from the engine 102 and communicate the electrical power to one or more electrical loads 114 of the machine 100. The load 114 may include, for example, motors for causing motion of the machine 100 as well as motors for operating various mechanical tools of the machine 100. As is well known in the art, the motor 110 may include a rotor 116 that is rotatably disposed within a fixed stator 118. The rotor 116 may be coupled to an output of the engine 102 via the drive shaft 112, or in other related embodiments, via a direct crankshaft, a gear train, a hydraulic circuit, and the like. The stator 118 may be electrically coupled to a common bus 120 of the electric drive 104 via a control circuit 122.

During a generating mode of operation, as the rotor 116 is rotated within the stator 118 by the engine 102, electrical current may be induced within the stator 118 and supplied to the control circuit 122. The control circuit 122 may in turn convert the electrical signals into an appropriate direct current (DC) voltage for distribution to the various electrical loads 114 of the machine 100. Additionally, the motor 110 may be enabled to cause rotation of the rotor 116 in response to electrical signals that are provided to the stator 118 from the common bus 120, for instance, during a motoring mode of operation. The common bus 120 may include a positive line 124 and a negative or ground line 126 across which a common DC bus voltage may be communicated to one or more loads 114 of the machine 100 coupled thereto. For instance, the control circuit 122 may provide a DC signal to be transmitted through the common bus 120 and to a rectifier circuit where the DC voltage may be converted into the appropriate alternating current (AC) signals for driving the one or more traction motors, or the like, for causing motion of the machine 100 via the traction device 106. The common bus 120 may also communicate the common DC voltage to other loads 114 of the machine 100, such as a hybrid system, electrically driven pumps, electrically driven fans, and the like.

Still referring to FIG. 2, the electric drive 104 may also be provided with a transition control system 128 for controlling the motor 110. The transition control system 128 may essentially include a controller 130 that is in communication with at least the control circuit 122 associated with the electric drive 104. The control circuit 122 may include a series of transistors or gated switches 132 and diodes 134 for selectively enabling one or more phase windings of the motor 110. A three-phase SR motor 110, for example, may be driven using a control circuit 122 having six switches 132 and six diodes 134 for selectively enabling or disabling each of the three phases of the motor 110. Each of the switches 132 may be enabled or disabled via gate signals, which may be supplied by the controller 130. In particular modifications, the transition control system 128 may also be provided with encoders, speed sensors 136, or the like, adapted to generate a speed sensor signal corresponding to the rotational position and/or frequency of the rotor 116 relative to the stator 118 and communicate the speed sensor signal to an input of the controller 130. The speed sensors 136 may include a Hall-effect sensor, a variable reluctance sensor, an anisotropic magnetoresistance sensor, or the like. Power to the transition control system 128 and the control circuit 122 may be provided by an external or secondary power source, such as provided by a battery (not shown), residual voltage stored in a capacitor 138 of the common bus 120, or any other suitable current limited DC power supply.

By communicating with the motor 110 and the control circuit 122, the controller 130 may be configured to monitor and provide appropriate control over the operational state of the motor 110 and the associated electric drive 104. In applications employing an SR motor 110, for example, the controller 130 may be configured to determine the appropriate mode for operating the motor 110 based at least on the observed motor speed. More specifically, the controller 130 may monitor and compare the observed speed with one or more predefined speed thresholds to determine if the motor speed corresponds to a relatively low speed, a nominal or mid-range speed, a relatively high speed, or the like. If the observed speed is nominal or relatively low, the controller 130 may be configured to engage a current regulation mode of operating the motor 110. During the current regulation mode, the controller 130 may transmit gate signals configured to enable one or both of the switches 132 associated with each phase of the motor 110 in a pulsing or chopping manner so as to operate the motor 110 in a constant torque range of output. Alternatively, if the observed speed is relatively high, the controller 130 may be configured to engage a single pulse mode of operating the motor 110. During the single pulse mode, the controller 130 may transmit gate signals configured to continuously enable both of the switches 132 of the control circuit 122 associated with each phase of the motor 110 so as to operate the motor 110 in a constant power range of output.

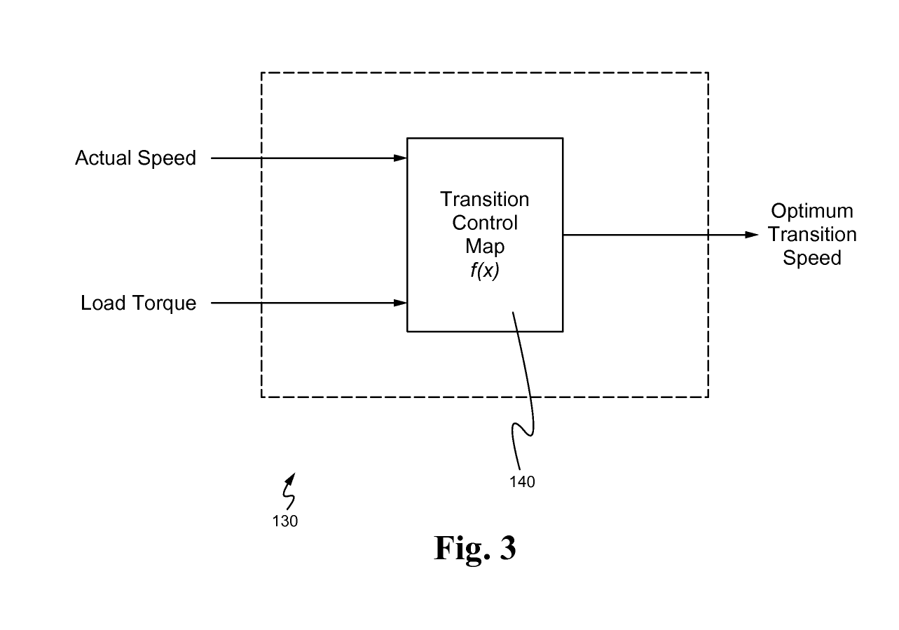

Accordingly, based at least on the actual speed of the motor 110, the controller 130 of the transition control system 128 in FIG. 2 may be able to switch motor operations between the current regulation and single pulse modes. In order to perform a more natural transition between the current regulation and single pulse modes of operation, the controller 130 may further be configured to engage the transition at an optimum transition speed that is determined based at least on the observed speed as well as the load torque of the motor 110. More specifically, as illustrated in FIG. 3, the controller 130 may receive speed and load torque sensor signals so as to monitor the actual speed and the observed load torque data values of the motor 110. The controller 130 may be programmed with a predefined function which computes the optimum transition speed based on the actual speed and the load torque values observed. Additionally or alternatively, the controller 130 may be preprogrammed with a transition control map 140, a lookup table, or the like, configured to output the optimum transition speed based on the actual speed and the load torque of the motor 110. The controller 130 may be implemented using one or more of a processor, a microprocessor, a microcontroller, an electronic control module (ECM), an electronic control unit (ECU), or any other suitable means for providing electronic control of the transition speed of the motor 110. Furthermore, the controller 130 may be configured to operate according to a predetermined algorithm or set of instructions for engaging the transition based on characteristics of the motor 110, the engine 102, the electric drive 104, and the like. Such an algorithm or set of instructions may be preprogrammed or incorporated into a memory of the controller 130 as is commonly known in the art.

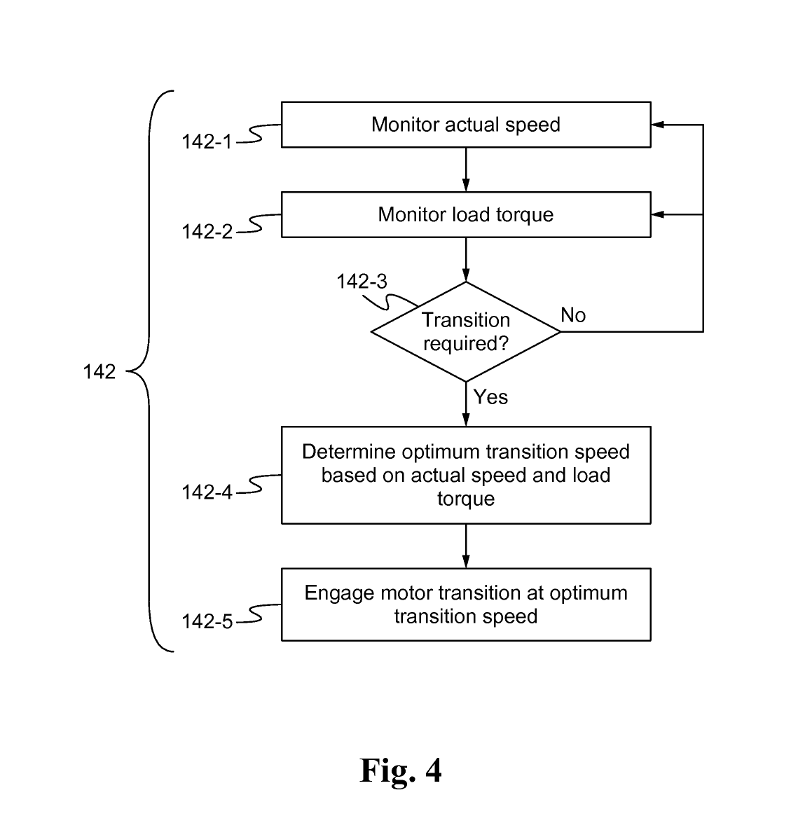

Referring now to FIG. 4, an exemplary algorithm or method 142 by which the controller 130 may be configured to control a transition of the motor 110 is provided. In an initial step 142-1, the controller 130 may be configured to monitor an actual speed of the motor 110, for example, based on the signals provided by the speed sensors 136, and the like. In step 142-2, the controller 130 may additionally monitor the load torque of the motor 110. Moreover, the controller 130 may be configured to continuously monitor both of the actual speed and the load torque of the motor 110 throughout use of the associated work or mobile machine 100 in order to determine the appropriate mode of operating the motor 110. For example, if the actual speed of the motor 110 is relatively low, the controller 130 may engage the motor 110 in current regulation mode corresponding to a constant torque range of output. If the actual speed of the motor 110 is relatively high or mid-range, the controller 130 may engage the motor 110 in single pulse mode corresponding to a constant power range of output.

As shown in step 142-3 of the method 142 of FIG. 4, the controller 130 may also be configured to determine whether a transition between the two modes of operation, for example, between the current regulation and single pulse modes of operation, is required. The controller 130 may determine the need for a transition between modes of operation using any suitable manner or technique. For example, the controller 130 may be configured to monitor the motor current, or current passing through the phases of the motor 110, for a predefined unique single peak value point. In particular, the motor current may reach the unique single peak value point when a voltage applied to the motor 110 substantially equates the sum of the back electromotive force (EMF) voltage of the motor 110 and the resistive voltage drop at the current reference level for the particular load torque. The controller 130 may thus continue monitoring the actual speed and the load torque values of the motor 110 until the motor current reaches such a unique single peak value point. If the motor current does reach the unique single peak value point, the controller 130 may determine that a transition is required and proceed to step 142-4.

In step 142-4, the controller 130 may be configured to determine the optimum transition speed, or the speed most appropriate for enabling a smooth and natural transition of the motor 110 between current regulation and single pulse modes of operation. As illustrated in FIG. 3, the controller 130 may compute the optimum transition speed using a predefined function and based on at least the actual speed and load torque values observed in steps 142-1 and 142-2. The controller 130 may additionally, optionally or alternatively determine the optimum transition speed using the preprogrammed transition control map 140 of FIG. 3. Specifically, the transition control map 140 may suggest or lookup the optimum transition speed based on the combination of the actual speed and load torque observed in steps 142-1 and 142-2. Once the optimum transition speed is determined in step 142-4, the controller 130 may be configured to switch the motor 110 between the current regulation and single pulse modes of operation in step 142-5. Moreover, the controller 130 may engage the motor 110 to switch modes at the optimum transition speed determined in step 142-4.

### INDUSTRIAL APPLICABILITY

In general, the foregoing disclosure finds utility in various industrial applications, such as the farming, construction and mining industries in providing smoother and more efficient control of motors typically used in association with work vehicles and/or machines, such as tractors, backhoe loaders, compactors, feller bunchers, forest machines, industrial loaders, skid steer loaders, wheel loaders, and the like. More specifically, the disclosed control systems and methods may be applied to electric drive assemblies and machines having switched reluctance motors or other comparable motors commonly used in the art. The systems and methods disclosed herein provide adaptive transition control of switched reluctance machines based on the actual speed and load torque. More specifically, a transition control map is provided to suggest the most appropriate speed at which to perform the transition between current regulation and single pulse modes of operation. By enabling more natural transitions between constant torque and constant power regions, the utilization of machine power and torque across the transition speed region as well as the overall efficiency of the machine are improved.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of controlling a motor, comprising the steps of:
monitoring a plurality of operational characteristics of the motor;
determining an optimum transition speed of the motor based on the operational characteristics; and
engaging a transition of the motor between a current regulation mode of operation and a single pulse mode of operation at the optimum transition speed.

2. The method of claim 1, wherein the motor is a switched reluctance motor configured to generate constant torque while operating in the current regulation mode, and generate constant power while operating in the single pulse mode.

3. The method of claim 1, wherein the operational characteristics includes data pertaining to at least an actual speed of the motor and a load torque of the motor.

4. The method of claim 1, wherein the optimum transition speed is computed using a predefined function of at least an actual speed of the motor and a load torque of the motor.

5. The method of claim 1, wherein the optimum transition speed is determined using a predefined transition control map configured to output the optimum transition speed based on an actual speed of the motor and a load torque of the motor.

6. The method of claim 5, wherein the transition control map is preprogrammed with a lookup table having a plurality of optimum transition speed values corresponding to different actual speed and load torque values.

7. The method of claim 1, wherein the transition is engaged when motor current reaches a unique single peak value point.

8. The method of claim 7, wherein the motor current reaches the single peak value point when a voltage applied to the motor substantially equates a sum of a back electromotive force (EMF) voltage and a resistive voltage drop at a current reference level for a particular load torque.

9. A method of controlling a transition of a switched reluctance motor between current regulation operation and single pulse operation, comprising the steps of:
monitoring an actual speed of the motor;
monitoring a load torque of the motor;
determining an optimum transition speed of the motor based on a predefined transition control map, the transition control map being configured to output the optimum transition speed based on the actual speed and the load torque of the motor; and
engaging the transition when motor current reaches a unique single peak value point.

10. The method of claim 9, wherein the motor is configured to generate constant torque while operating in the current regulation mode, and generate constant power while operating in the single pulse mode.

11. The method of claim 9, wherein the optimum transition speed is computed using a predefined function of at least the actual speed and the load torque of the motor.

12. The method of claim 9, wherein the optimum transition speed is determined using a predefined transition control map configured to output the optimum transition speed based on the actual speed and the load torque of the motor.

13. The method of claim 12, wherein the transition control map is preprogrammed with a lookup table having a plurality of optimum transition speed values corresponding to different actual speed and load torque values.

14. The method of claim 9, wherein the motor current reaches the single peak value point when a voltage applied to the motor substantially equates a sum of a back electromotive force (EMF) voltage and a resistive voltage drop at a current reference level for a particular load torque.

15. A transition control system for a motor, comprising:
a control circuit operatively coupled to at least one or more phases of a stator of the motor; and
a controller in communication with each of the motor and the control circuit, the controller configured to monitor an actual speed and a load torque of the motor, determine an optimum transition speed of the motor based on the actual speed and the load torque, and enable the control circuit to engage a transition of the motor between a current regulation mode of operation and a single pulse mode of operation at the optimum transition speed.

16. The control system of claim 15, wherein the motor is a switched reluctance motor capable of operating in one of at least the current regulation mode and the single pulse mode, the current regulation mode corresponding to constant torque output and the single pulse mode corresponding to constant power output.

17. The control system of claim 15, wherein the optimum transition speed is computed using a predefined function of at least an actual speed of the motor and a load torque of the motor.

18. The control system of claim 15, wherein the optimum transition speed is determined using a predefined transition control map configured to output the optimum transition speed based on the actual speed and the load torque of the motor.

19. The control system of claim 18, wherein the transition control map is preprogrammed with a lookup table having a plurality of optimum transition speed values corresponding to different actual speed and load torque values.

20. The control system of claim 15, wherein the transition is engaged when motor current reaches a unique single peak value point, the motor current reaching the single peak value point when a voltage applied to the motor substantially equates a sum of a back electromotive force (EMF) voltage and a resistive voltage drop at a current reference level for a particular load torque.
